(19) United States
(12) Patent Application Publication
(10) Pub. No.: US 2009/0140689 A1
(43) Pub. Date: Jun. 4, 2009

(54) SOLAR CHARGER

(76) Inventor: Vincent Lee, Taipei County (TW)

Correspondence Address: Vincent Lee, 235 Chung - Ho, Box 8-24, Taipei, TW

(21) Appl. No.: 11/949,758

(22) Filed: Dec. 3, 2007

(51) Int. Cl. H02J 7/00

(52) U.S. Cl. 320/101

(57) ABSTRACT

A solar charger primarily comprises a main body and at least one solar panel wherein the main body and the solar panel are respectively an independent modulized component. In addition, one edge of the solar panel can be detachably attached to one adjacent edge of the main body. Since contacts are respectively provided on the adjacent edges of the solar panel and the main body, the two components are electrically connected when they are assembled together so as to store an electric power transformed from a light energy in a rechargeable battery in the main body for providing the electric power to charge electronic devices later. Thereupon, the present invention facilitates manufacturing as well as processing and reduces time consumption of fabricating.

### BACKGROUND OF THE INVENTION

1. Technical Field

The present invention relates to solar chargers and, more particularly, to a solar charger comprising one main body and at least one solar panel, which are respectively an independent modulized component, wherein the solar panel can be detachably attached to the main body.

2. Description of Related Art

There are many portable 3C electronic devices available on the market, such as PDA, ipod and DV. Users bringing these electronic devices out or during their travel usually bring extra batteries for preventing the electronic devices from running out of power. For those users don't have extra batteries, they may have to bring chargers instead. A traditional charger typically uses a wire connected with an AC/DC (alternating current/direct current) converter that further connected with an outlet of the grid to charge a battery of a mentioned electronic device. However, when power cut happens or when the user is in the outdoors where a power outlet is not accessible, it is impossible to charge the electronic device through the traditional charger. Therefore, various solar charging devices have been successively developed and introduced to the market. Such a solar charging device employs a solar panel to collect light from an external light source and transform a light energy of the light into an electric energy for being stored in an internal rechargeable battery thereof so that the electric energy stored in the internal rechargeable battery can be used to charge electric devices without need of the grid. Hence, the known solar charging devices are somehow convenient to the users.

Nevertheless, the solar charging devices of the prior arts still have problems to be remedied. These solar charging devices, in that main, have the solar panels integrated with the main bodies, or alternatively have the solar panels, pivotably, or reversibly and foldably attached to the main body in an undetachable manner. Thus, some of them are inevitably complicated and require relatively higher costs of manufacturing, processing and fabricating.

### SUMMARY OF THE INVENTION

The present invention has been accomplished under these circumstances in view. It is one objective of the present invention to provide a solar charger that can be produced with reduced costs of manufacturing, processing and fabricating. In particular, when one of the main body and the solar panel is broken or lost replacement or supplement can be only conducted upon the broken or lost component so as to reduce unnecessary waste. In addition, the present invention provides convenience regarding assembling, disassembling, and compacting so as to facilitate portability and storage of the disclosed subject matter.

To achieve above object, the present invention provides a solar charger, comprising a main body and at least one solar panel, wherein: the main body has a housing, a rechargeable battery settled in the housing, at least one contact provided on the housing, and a power output unit connected to the rechargeable battery, in which the at least one contact is positioned at least one edge of the housing; and the solar panel has one edge thereof detachably attached to the main body and comprises a contact positioned on the edge so that when the solar panel is assembled to the main body, the contact of the solar panel and the contact of the main body are electrically connected.

The disclosure of present invention permits the main body and the solar panel of a solar charger to be separately made as a respective modulized component, so as to save costs of manufacturing as well as processing and reduce time consumption during fabricating. Further, when one of the main body and the solar panel is broken or lost, replacement or supplement can be conducted upon the broken or lost component without discarding the entire solar charger so as to reduce unnecessary waste. Moreover, according to the present invention, the assembly, disassembly, and compacting between the main body and the solar panels are facile and rapid. Particularly, the two solar panels can be assembled at one of the edges of the main body for storage in the manner that the light collecting surfaces of the two solar panels face each other so as to protect the light collecting surfaces from being impacted or scraped. Consequently, the safety of the solar panels is ensured and the overall width of the solar charger can be substantially reduced so as to reduce required space and facilitate portability as well as storage. Furthermore, one or both of the solar panels can be assembled to the main body according to practical needs, so as to permit enhanced flexibility of assembly. Thereupon, the efficiency of power transformation and store can be freely controlled by the user. Additionally, the user can determine to charge the rechargeable battery with the solar panels or a normal AC or DC source so that the solar charger is prevented from lacking for an accessible power source.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective drawing of the subject matter of the present invention showing the solar panel and the main body disassembled;

FIG. 2 is another perspective drawing of the subject matter of the present invention showing the solar panel and the main body assembled and the solar charger at an extended state;

FIG. 3 is a perspective drawing showing that the two solar panels having the light collecting surfaces thereof facing each other are assembled at one edge of the main body, and the solar charger is at an compacted state, wherein a plurality of indication lamps are provided on the main body;

FIG. 4 is another perspective drawing showing the disclosed subject matter at the compacted state wherein the two solar panels having the light collecting surfaces thereof facing each other are assembled at one edge of the main body, and a power input unit as well as a power output unit provided on the main body;

FIG. 5 is a perspective view of the main body of the present invention showing a plurality of indication lamps provided thereon;

FIG. 6 is another perspective view of the main body of the present invention showing a power input unit and a power output unit provided; and

FIG. 7 is a schematic block diagram of the present invention.

### DETAILED DESCRIPTION OF THE PREFERRED EMBODIMENT

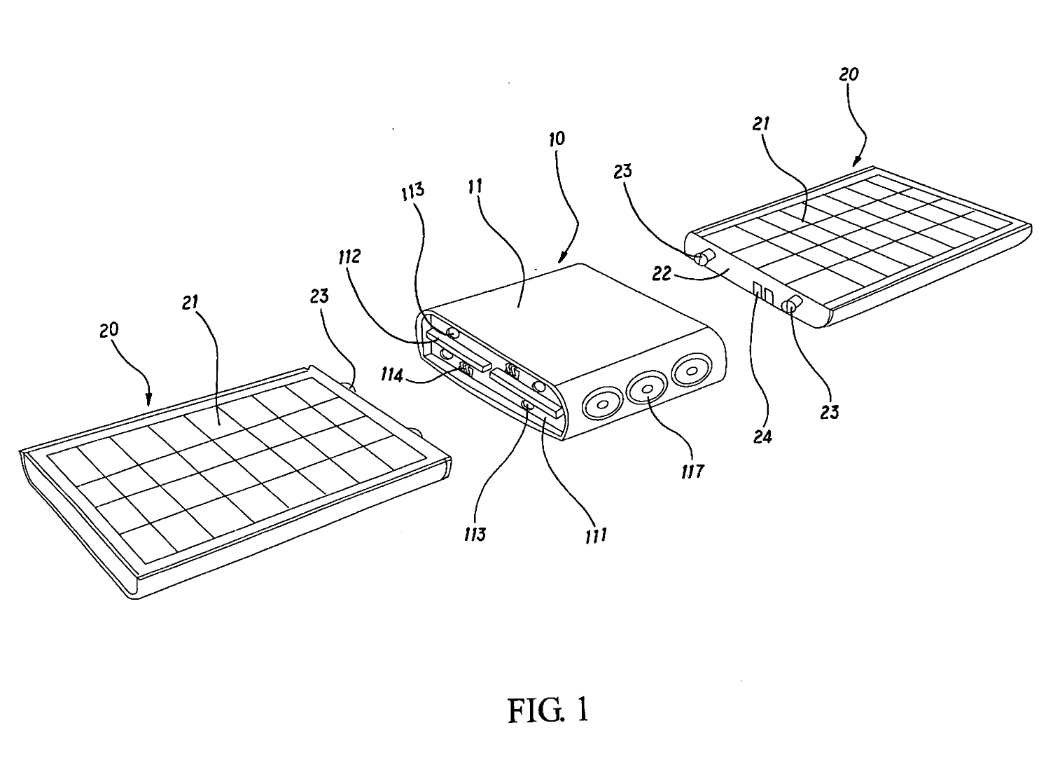

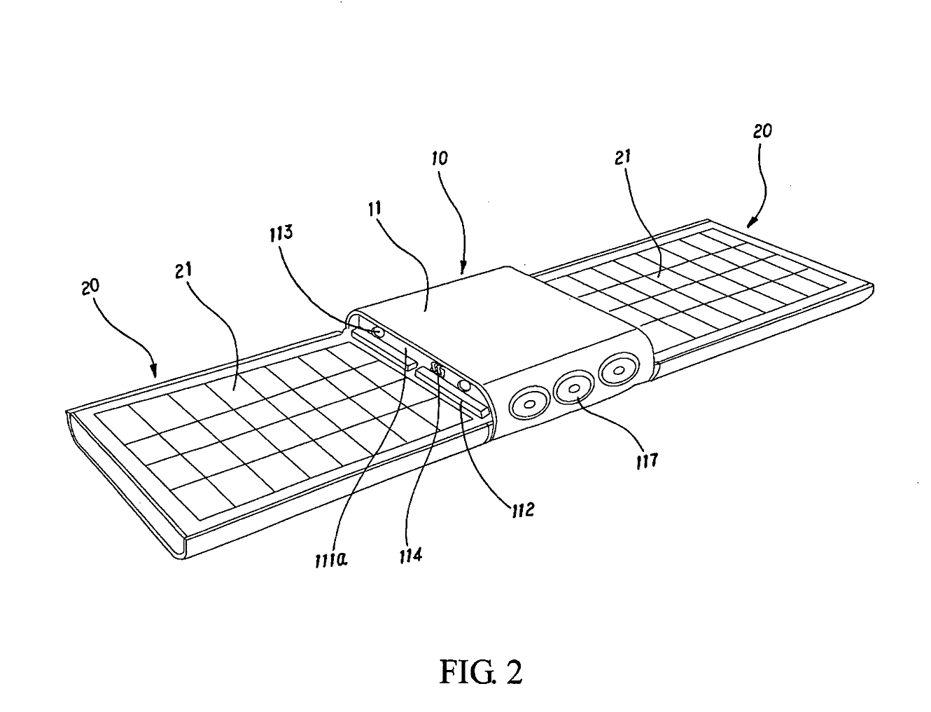

Please refer to FIGS. 1 and 2 for one preferred embodiment of the solar charger of the present invention. The solar charger comprises a main body 10 and two solar panels 20, which will be further explained in detail through the following description.

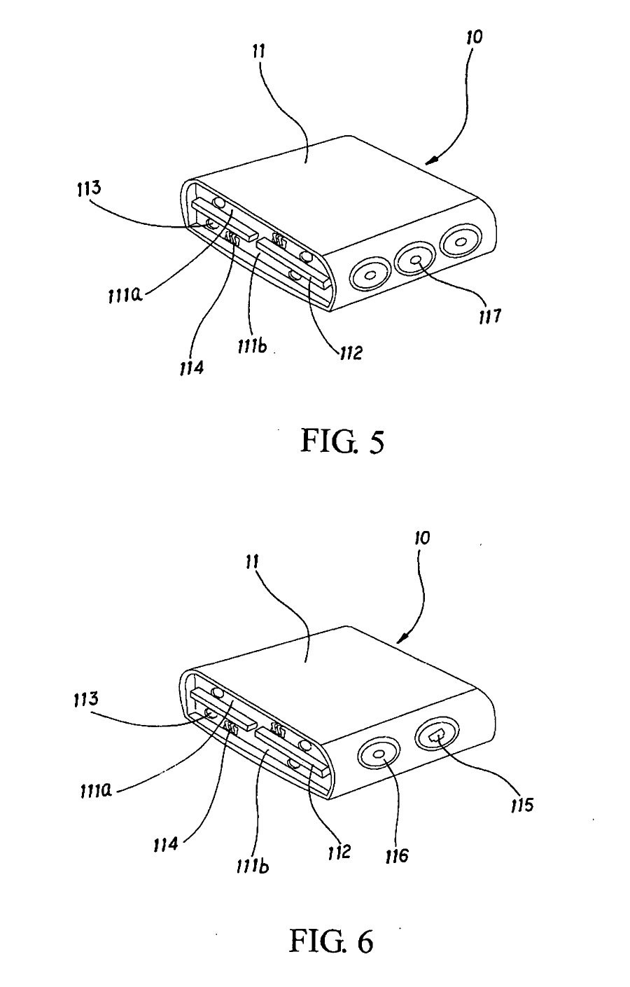

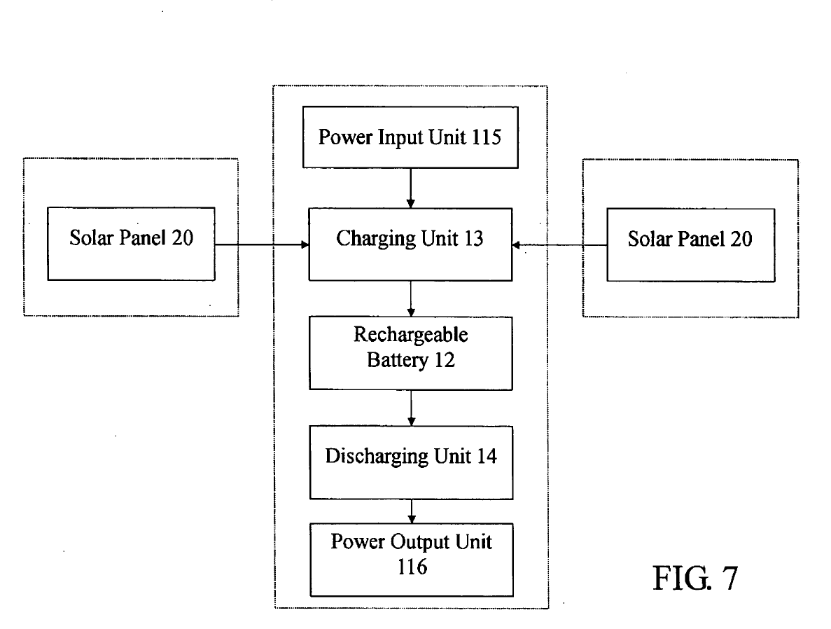

The main body 10, referring also to FIGS. 5, 6 and 7, comprises a approximately rectangular housing 11. Inside the housing 11, a rechargeable battery 12 and a circuit board (not shown) are provided. A charging unit 13 and a discharging unit 14 are arranged on the circuit board and are respectively connected to the rechargeable battery 12, as shown in FIG. 7, for preventing the rechargeable battery 12 from being over charged or over discharged. Further, each of two opposite edges of the housing 11 has a depressed portion 111, and two partitions 112 are transversely positioned in a middle part of the depressed portion 111 and distant from each other with a proper distance so that the depressed portion 111 is divided into a first depressed portion 111a and a second depressed portion 111b. Two sockets 113 and a contact 114 located between the two sockets 113 are provided at each of the first depressed portion 111a and the second depressed portion 111b. Therein, the contacts 114 are respectively connected to the charging unit 13. Moreover, a power input unit 115 and a power output unit 116 are provided at another edge of the housing 11. According to the present embodiment, the power input unit 115 is an AC input port complying with the mini USB specification and shaped as a raised socket. The power output unit 116 is a DC output port and shaped as a round socket. Therein, the power input unit 115 is connected to the charging unit 13, and the power output unit 116 is connected to the discharging unit 14. In addition, in yet another edge of the housing 11, three indication lamps 117 are provided for indicating a power status of the rechargeable battery 12.

The solar panels 20 are approximately rectangular plates. On each of the solar panels 20, a light collecting surface 21 is formed with a relatively large area while two protruding anchor bolts 23 and a contact 24 located between the two anchor bolts 23 are provided at one edge 22 thereof. Thereupon, when the anchor bolts 23 at the edge 22 of the solar panels 20 are respectively inserted into and engaged with the sockets 113 at the first depressed portion 111a or the second depressed portion 111b on either of the adjacent edges of the housing 11 of the main body 10, the solar panels 20 can be attached to the main body 10 and the solar charger is at an extended state, as shown in FIG. 2. Meantime, the edges 22 of the solar panels 20 are designed to be fittingly received and retained by the first depressed portions 111a or the second depressed portions 111b so as to ensure tightness and firmness of the assembled solar charger. When the solar panels 20 are properly attached to the main body 10, the contacts 24 at the edges 22 thereof can just electrically contact the contacts 114 on the adjacent edges of the housing 11, so that the solar panels 20 can store an electric energy transformed from a light energy in the rechargeable battery 12 inside the main body 10 through the electrically connected contacts 114 and 24.

Referring to FIGS. 1 and 7, in the disclosed solar charger, a power input unit 115 is provided on the housing 11 of the main body 10. When the rechargeable battery 12 in the housing 11 of the main body 10 is low on power, a user can connect an AC/DC converter (not shown) that is further connected with the grid to the main body 10 so as to convert an AC power of the grid into a DC power and store the DC power in the rechargeable battery 12 through the power input unit 115. Meantime, the user can identify the power status of the rechargeable battery 12 through the indication lamp 117 on the housing 11 and the user can plug a wire of an electronic device into the power outlet unit 116 of the main body 10 so as to recharge the electronic device with the rechargeable battery 12.

When the grid is not available, the user can alternatively use the solar panels 20 to charge the rechargeable battery 12. In operation, the user can determine to assemble one of the solar panels 20 to the edge of the main body 10 or to assemble both of the solar panels 20 to the two edges of the main body 10, as shown in FIG. 2. Then the user can face the light collecting surfaces 21 of the solar panels 20 to an external light source, so as to collect the external light and transform the light energy into electric energy before storing the electric energy in the rechargeable battery 12 of the main body 10 for being supplied to electronic devices later.

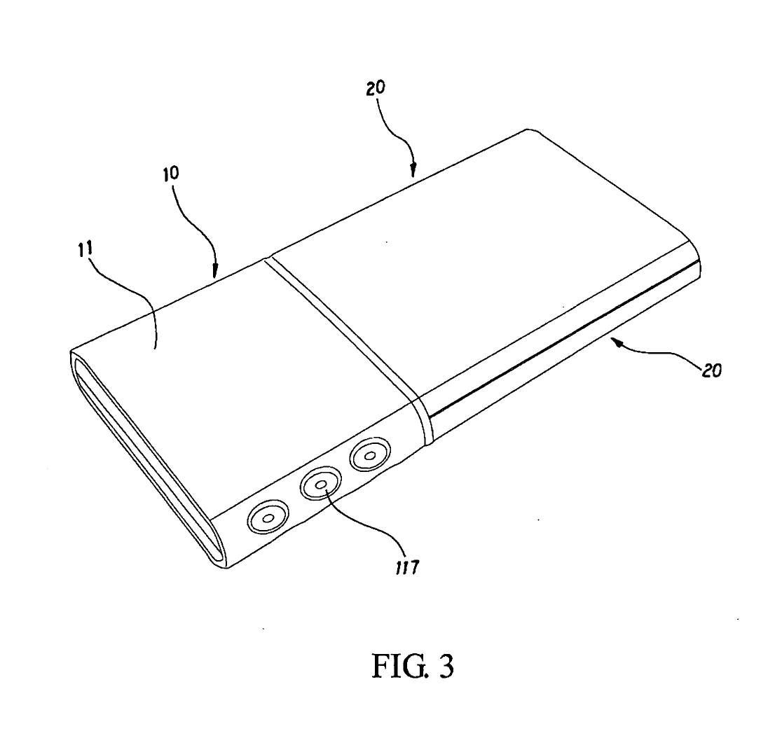

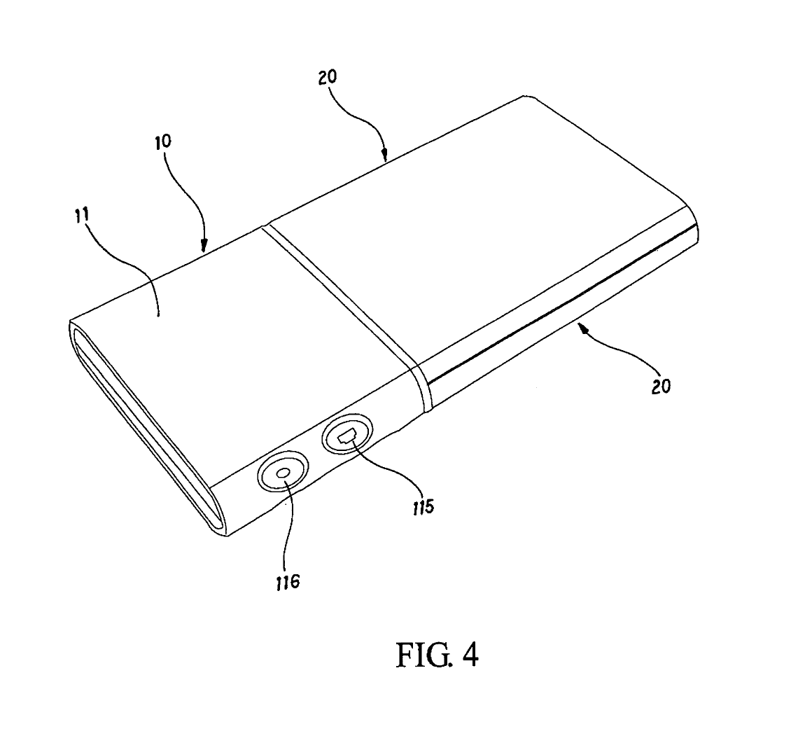

Besides, when the disclosed solar charger is not in use, the solar panels 20 can be assembled to the first depressed portion 111a and the second depressed portion 111b of either edge 22 of the housing 11 of the main body 10 in the manner that the light collecting surfaces 21 of the two solar panels 20 face each other, as shown in FIGS. 3 and 4. Thereupon, the light collecting surfaces 21 of the two solar panels 20 are prevented from being exposed without any shield and therefore are protected from damages caused by impacting and scraping. Consequently, safety of the light collecting surfaces 21 during being carried and stored can be ensured. On the other hand, overall width of the solar charger can be reduced thereby, and therefore less space is taken during carrying and storing the disclosed solar charger.

Besides, in addition to the sockets 113 and the anchor bolts 23, the housing 11 of the main body 10 and the solar panels 20 may be alternatively connected by magnets (not shown) that are mutually attract or other commercially available mechanical structures. It is to be understood that the structure described in the embodiment is not a limitation of the present invention and any mechanical structure allowing the solar panels 20 to be detachably attached to the main body 10 is compliable to the spirit of the present invention.

According to the above description, the features and effects of the present invention can be concluded into the following points:

1. When one of the main body 10 and the solar panel 20 is broken or lost, replacement or supplement can be only conducted upon the broken or lost component. Thus, dissimilar to the prior arts that in the same circumstances, the entire solar charging devices have to be discarded and the user has to repurchase an entire new solar charging device, the disclosed subject matter reduces unnecessary waste.

2. The two solar panels 20 can be assembled at one of the edges of the main body 10 in the manner that the light collecting surfaces 21 thereof face each other so as to enhance the safety of the solar panels 20 by protecting the light collecting surfaces 21 from being impacted or scraped. On the other hand, the overall width of the solar charger can be substantially reduced so as to reduce required space and facilitate portability as well as storage.

3. The main body 10 of the disclosed solar charger can be attached by one of the solar panels 20 or, alternatively, attached by both of the solar panels 20 according to practical needs, so as to permit enhanced flexibility of assembly. Thereupon, the efficiency of power transformation and store can be freely controlled by the user.

4. The solar charger is adapted for being charged by the solar panels 20 and a normal AC or DC power source so that the solar charger is prevented from lacking for an accessible power source.

What is claimed is:

1. A solar charger, comprising a main body and at least one solar panel, wherein:
the main body has a housing, a rechargeable battery settled in the housing, at least one contact provided on the housing, and a power output unit connected to the rechargeable battery, in which the at least one contact is positioned at least one edge of the housing; and
the solar panel has one edge thereof detachably attached to the main body and comprises a contact positioned on the edge so that when the solar panel is assembled to the main body, the contact of the solar panel and the contact of the main body are electrically connected.

2. The solar charger of claim 1, wherein sockets and an anchor bolts which can mutually engage are provided between connecting portions of the housing of the main body and the solar panel so that the solar panel can be detachably attached to the main body.

3. The solar charger of claim 1, wherein magnets can mutually attract are provided between connecting portions of the housing of the main body and the solar panel so that the solar panel can be detachably attached to the main body.

4. The solar charger of claim 1, wherein a depressed portion is formed on the housing of the main body at a position where the solar panel is attached to the housing of the main body for fittingly receiving an adjacent edge of the solar panel retained therein.

5. The solar charger of claim 1, wherein a depressed portion is formed on the housing of the main body at a position where the solar panel is attached to the housing of the main body for fittingly receiving adjacent edges of two said solar panels that have the light collecting surfaces face each other retained therein.

6. The solar charger of claim 5, wherein at least one partition is provided in the depressed portion formed on the housing of the main body for dividing the depressed portion into a first depressed portion and a second depressed portion for respectively fittingly receiving one of the adjacent edges of the two solar panels that have the light collecting surfaces face each other retained therein.

7. The solar charger of claim 1, wherein an edge of the housing of the main body fittingly receives adjacent edges of two said solar panels that have the light collecting surfaces face each other retained therein.

8. The solar charger of claim 1, wherein the power output unit is a DC output port.

9. The solar charger of claim 8, wherein the DC output port is a round socket.

10. The solar charger of claim 1, wherein a power input unit is provided on the housing of the main body for connecting to the rechargeable battery inside the housing.

11. The solar charger of claim 10, wherein the power input unit is an DC input port.

12. The solar charger of claim 11, wherein the DC input port is a raised socket of a mini USB socket specification.

13. The solar charger of claim 10, wherein the main body is able to transform an AC (alternating current) power into a DC (direct current) power in cooperation with an AC/DC converter and charge the rechargeable battery with the power input unit.

14. The solar charger of claim 1, wherein a plurality of indication lamps are provided on the housing of the main body for indicating a power status of the rechargeable battery.

15. The solar charger of claim 1, wherein the main body further comprises a charging unit and a discharging unit settled therein, in which the charging unit is connected between the contact of the housing and the rechargeable battery while the discharging unit is connected between the rechargeable battery and the power output unit.

16. The solar charger of claim 15, wherein the charging unit and the discharging unit are formed in a circuit board.
